(19) United States
(12) Patent Application Publication
(10) Pub. No.: US 2024/0107104 A1
(43) Pub. Date: Mar. 28, 2024

(54) SYSTEMS AND METHODS FOR BROADCASTING A SINGLE MEDIA STREAM COMPOSITED WITH METADATA FROM A PLURALITY OF BROADCASTER COMPUTING DEVICES

(71) Applicant: Meta Platforms, Inc., Menlo Park, CA (US)

(72) Inventors: Bo Huai Victor Loh, Redwood City, CA (US); Hemal Khatri, Redmond, WA (US)

(21) Appl. No.: 17/587,711

(22) Filed: Jan. 28, 2022

(51) Int. Cl. H04N 21/43; H04L 65/60; H04L 65/65; H04N 21/439

(52) U.S. Cl. CPC H04N 21/43079; H04L 65/601; H04L 65/608; H04N 21/43072; H04N 21/4394

(57) ABSTRACT

The disclosed computer-implemented method may include systems and methods for generating a composited single media stream from multiple data streams of broadcasting computing devices. For example, systems and method described herein can receive audio-only streams and metadata from broadcasting computing device. The systems and methods described herein can further combine and transform the received audio-only streams into a single media stream. The systems and methods described herein may also synchronize and composite the metadata back into the single media stream, such that information from the broadcasting computing device may be passed all the way to listener computing devices when the composited single media stream is broadcasted to the listener computing devices. Various other methods, systems, and computer-readable media are also disclosed.

### CROSS REFERENCE TO RELATED APPLICATION

This application is related to U.S. application Ser. No. 17/573,519, filed Jan. 11, 2022, the disclosure of which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a network environment in which an example session broadcasting system operates according to one or more embodiments.

FIG. 2 illustrates an example overview diagram of the session broadcasting system generating a composited single media stream from audio streams and metadata received from broadcasting computing devices according to one or more embodiments.

FIGS. 3A and 3B illustrate example schematic diagrams of the session broadcasting system and corresponding interactive session application according to one or more embodiments.

FIG. 4 illustrates an example sequence diagram of the session broadcasting system converting audio-only streams into a single media stream while transforming and injecting metadata into the single media stream according to one or more embodiments.

FIG. 5 illustrates an example interactive session interface including a highlight element that updates based on metadata from a received single media stream according to one or more embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Digital broadcasting systems may include features for streaming audio to multiple listener devices. For example, digital broadcasting systems may enable the transmission of audio streams from broadcasting devices to listener devices. As such, digital broadcasting systems may allow users to broadcast audio streams from their computing devices (e.g., laptops, smartphones, smart wearables) to other computing devices where other users may listen to the broadcasted audio streams.

Unfortunately, many digital broadcasting systems are technologically deficient in several regards. For instance, some digital broadcasting systems are typically restricted to a predetermined audience size. To illustrate, many digital broadcasting systems may utilize modes of telecommunication such as real time communication (RTC) to stream audio from broadcasters to listeners. To enable this type of telecommunication, such digital broadcasting systems establish and maintain communication channels from a broadcaster device to each listener device. As such, digital broadcasting systems may be limited to a predetermined number of audience members in each streaming session because those systems can only maintain that number of communication channels.

The inherent structural limitations of these telecommunication modes can cause many digital broadcasting systems to be inefficient. To illustrate, as digital broadcasting systems add additional paths between a broadcaster device and listener devices (e.g., due to the audience increasing), those digital broadcasting systems can often experience increased latency due to the processing demands of supporting numerous communication paths. Accordingly, as latency increases, many digital broadcasting systems can experience increased delays between data requests and responses—leading to additional system-wide slowdowns.

Moreover, digital broadcasting systems can be limited to a single type of media-broadcasting. For example, as discussed above, many digital broadcasting systems utilize modes of telecommunication to stream audio from broadcaster devices to listener devices. As such, many digital broadcasting systems can be limited to transmitting only digital audio within an audio-streaming session. Accordingly, such digital broadcasting systems may ignore or inaccurately represent additional relevant information associated with the audio-streaming session (e.g., broadcaster status and information).

The present disclosure, in contrast, is generally directed to systems and methods for accurately and efficiently transmitting audio streams as well as additional metadata from broadcaster computing devices to listener computing devices. As will be explained in greater detail below, embodiments of the present disclosure may receive audio-only streams as well as metadata from one or more broadcaster devices. After receiving the audio-only streams and metadata, embodiments of the present disclosure can convert the audio-only streams into a single media stream while compositing the metadata into the single media stream. Embodiments of the present disclosure can further broadcast the single media stream to listener computing devices. Some embodiments of the present disclosure composite the metadata into the single media stream to inform audio stream player updates on the listener computing devices that reflect various broadcaster computing device characteristics.

As such, the systems and methods described herein can solve the technical issues common to many digital communication systems discussed above. For example, rather than being limited to a predetermined number of audience members in a streaming session, embodiments of the present disclosure may be scalable to any number of audience members per session. To illustrate, embodiments of the present disclosure can convert RTC streams from broadcaster computing devices to a single real-time messaging protocol (RTMP) data stream. In one or more embodiments, listener computing devices may request fragments of the RTMP data stream for assembly on the client-side. Thus, embodiments of the present disclosure can service requests from any number of listener computing devices and are not limited to a predetermined audience size.

Additionally, the systems and methods described herein may increase the efficiency of computing devices. For example, as mentioned above, embodiments of the present disclosure can convert multiple audio-only streams to a single media stream that is broadcasted to listener devices in response to data requests from those listener devices. Accordingly, embodiments of the present disclosure may operate at lower latency levels because they can broadcast the single media stream in response to data requests including preferred bitrates rather than supporting multiple direct paths between the listener computing devices and the broadcaster computing devices.

Furthermore, the systems and methods described herein may not be limited to broadcasting an audio-only stream. For example, as mentioned above, embodiments described herein can transmit metadata from broadcaster computing devices through to audio stream players on listener computing devices along with the audio streams from the broadcaster computing devices. One or more embodiments described herein can broadcast the metadata along with the audio to inform various audio stream player updates. For instance, one or more embodiments can broadcast the metadata along with the audio to cause the audio stream players to indicate a roster of broadcasters in the current interactive session, which broadcasters are muted, and which broadcaster is the active speaker in the currently interactive session.

Features from any of the embodiments described herein may be used in combination with one another in accordance with the general principles described herein. These and other embodiments, features, and advantages will be more fully understood upon reading the following detailed description in conjunction with the accompanying drawings and claims.

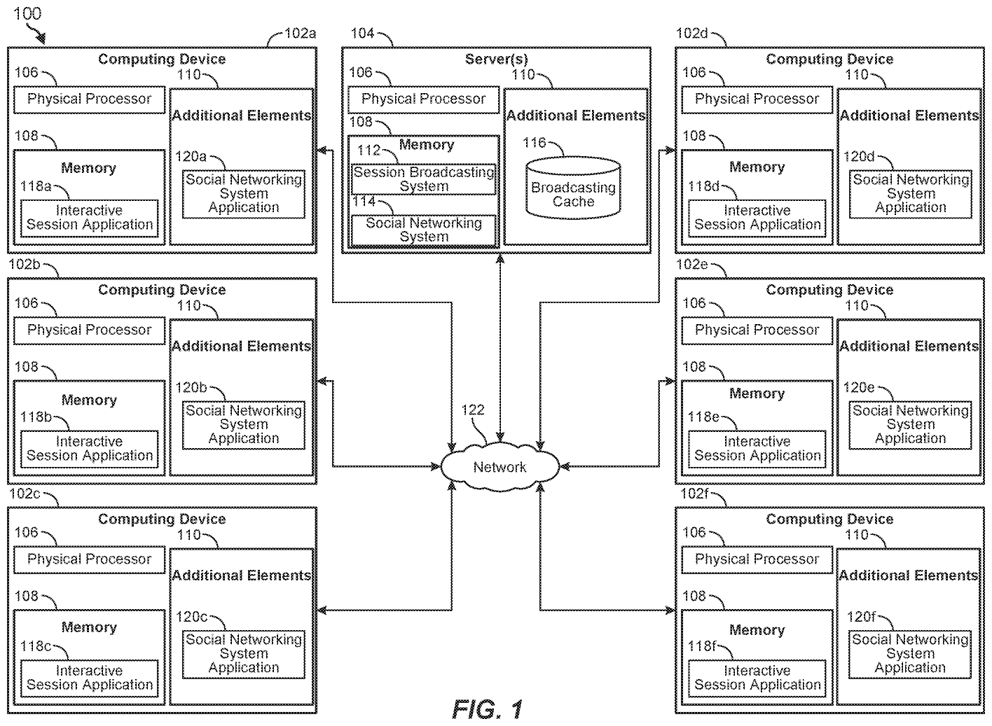

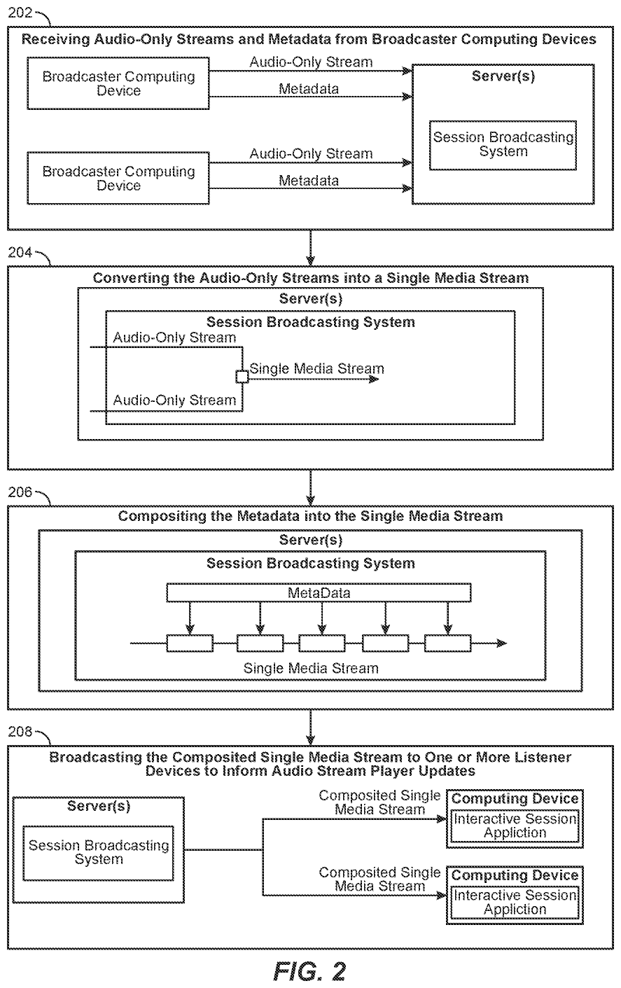

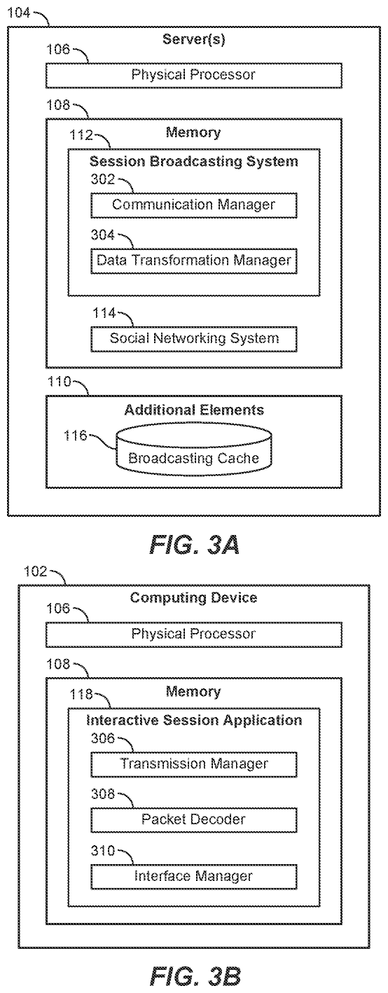

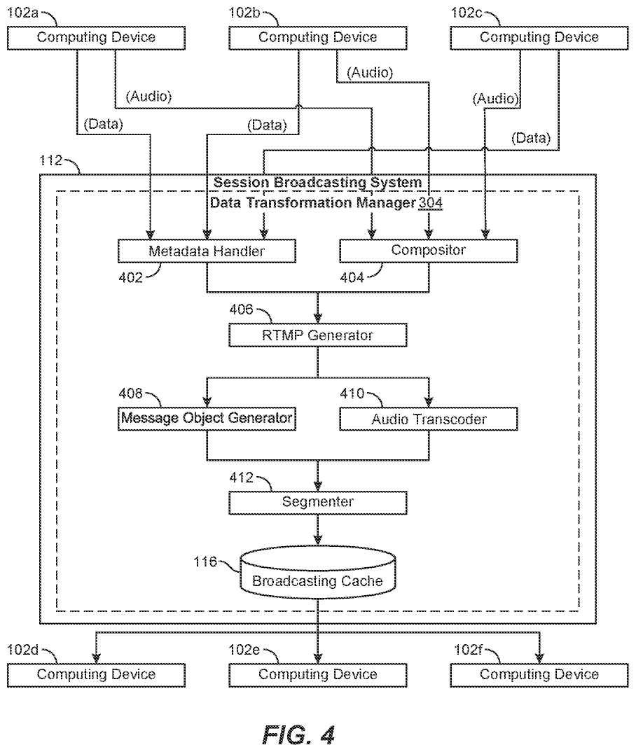

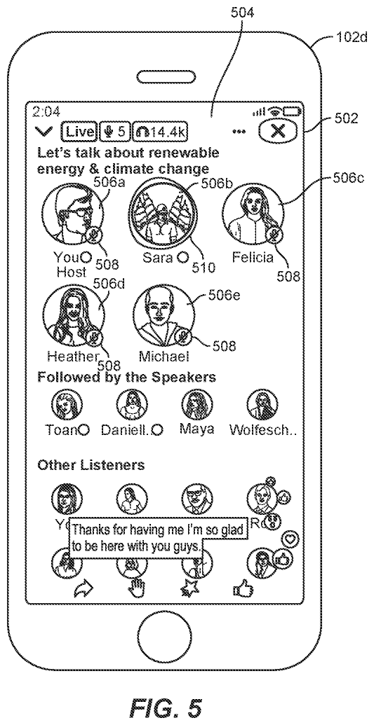

The following will provide, with reference to FIGS. 1-5, detailed descriptions of a session broadcasting system. For example, FIG. 1 illustrates a network environment in which the session broadcasting system operates, while FIG. 2 illustrates an overview of the session broadcasting system converting multiple audio-only streams and associated metadata into a single media stream that may be composited with the metadata. FIGS. 3A and 3B illustrate schematic diagrams of the session broadcasting system and the corresponding client-side interactive session application. FIG. 4 illustrates a detailed flow diagram of the session broadcasting system generating a composited single media stream for broadcast to listener devices. Finally, FIG. 5 illustrates a client-side audio stream player with an interactive session interface that updates based on metadata from the composited single media stream broadcasted by the session broadcasting system.

In more detail, FIG. 1 illustrates an exemplary network environment 100 implementing aspects of the present disclosure. For example, the network environment 100 can include server(s) 104, computing devices 102a, 102b, 102c, 102d, 102e, and 102f, and a network 122. In one or more embodiments, the server(s) 104 and computing devices 102a-102f can include a physical processor 106, a memory 108, and additional elements 110. As mentioned above, in one or more embodiments, a session broadcasting system 112 can be implemented by the server(s) 104.

As mentioned above, the session broadcasting system 112 can generate a single media stream from audio-only streams and metadata from broadcaster computing devices. As will be discussed in greater detail below, the session broadcasting system 112 generates the single media stream for an audience of any size while simultaneously reducing latency within the network environment 100. For example, in one or more embodiments, the session broadcasting system 112 receives audio-only streams and metadata from the computing devices 102a-102c (e.g., broadcaster computing devices) and provides a generated single media stream to the computing devices 102d-102f (e.g., listener computing devices). In at least one embodiment, the session broadcasting system 112 stores broadcasting elements (e.g., data packets, RTMP fragments, etc.) in a broadcasting cache 116 within the additional elements 110 of the server(s) 104. Although the broadcasting cache 116 is shown within the server(s) 104, in additional embodiments, the broadcasting cache 116 may be located separately from the server(s) 104. For example, the broadcasting cache 116 may be located on a separate server.

As further shown in FIG. 1, each of the computing devices 102a-102f can include an interactive session application 118a, 118b, 118c, 118d, 118e, and 118f, respectively. In one or more embodiments, the session broadcasting system 112 receives audio-only streams and metadata via the interactive session applications 118a-118c (e.g., broadcaster computing devices). Additionally, in one or more embodiments, the session broadcasting system 112 also provides a generated single media stream via the interactive session applications 118d-118f (e.g., listener computing device). In additional embodiments, any of the interactive session applications 118a-118f can provide data to and receive data from the session broadcasting system 112. In this manner, broadcasters (e.g., speakers within an interactive session) can receive a single media stream even while broadcasting, and listeners can be upgraded to broadcasters during an interactive session.

In one or more embodiments, the session broadcasting system 112 operates in concert with a social networking system 114. For example, in at least one embodiment, the session broadcasting system 112 provides tools and options for scheduling, initiating, participating in, and capturing an interactive session via the social networking system 114. To illustrate, the social networking system 114 can generate and provide customized newsfeeds of posts and other digital content to the computing devices 102a-102f via social networking system applications 120a, 120b, 120c, 120d, 120e, and 120f, respectively. The session broadcasting system 112 can also provide configuration tools to schedule and configure a future interactive session via any of the social networking system applications 120a-120f. Similarly, the session broadcasting system 112 can provide an access gateway to transmit and/or receive broadcasting data via any of the social networking system applications 120a-120f. Additionally or alternatively, the session broadcasting system 112 can provide this same functionality solely via the interactive session applications 118a-118f (i.e., the interactive session applications 118a-118f may be standalone applications).

The computing devices 102a-102f may be communicatively coupled to the server(s) 104 through the network 122. The network 122 may represent any type or form of communication network, such as the Internet, and may comprise one or more physical connections, such as a LAN, and/or wireless connections, such as a WAN.

Additionally, as shown in FIG. 1, the server(s) 104 and the computing devices 102a-102f can store components of the session broadcasting system 112 and/or the interactive session application 118 within memories 108. The memory 108 generally represents any type or form of volatile or non-volatile storage device or medium capable of storing data and/or computer-readable instructions. In one example, the memory 108 may store, load, and/or maintain one or more of the components the session broadcasting system 112 and/or the components of the interactive session application 118. Examples of the memory 108 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Also as illustrated in FIG. 1, the server(s) 104 and computing devices 102a-102f may also include one or more physical processors, such as a physical processor 106. The physical processor 106 generally represents any type or form of hardware-implemented processing unit capable of interpreting and/or executing computer-readable instructions. In one embodiment, the physical processor 106 may access and/or modify one or more of the components of the session broadcasting system 112 and/or the interactive session application 118. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, as shown in FIG. 1, the server(s) 104 and the computing devices 102a-102f may also include one or more additional elements 110. For example, in one or more embodiments, the additional elements 110 on the server(s) 104 can include additional data storage including the broadcasting cache 116. In one or more embodiments, the broadcasting cache 116 can include audio segments of a composited single media stream generated by the session broadcasting system 112. In one or more embodiments, the additional elements 110 on the computing devices 102a-102f can include a social networking system application 120a-120f, respectively. In one or more embodiments, the interactive session application 118 may function within or in connection with the social networking system application 120a-120f.

Although FIG. 1 illustrates components of the network environment 100 in one arrangement, other arrangements are possible. For example, in one embodiment, the session broadcasting system 112 and/or social networking system 114 may exist across multiple networked servers. In additional embodiments, the network environment 100 can include any number of computing devices such that there are multiple broadcasters and/or listeners (audience members).

As shown throughout, discussion of the features and functionalities of the session broadcasting system 112 references multiple terms. More detail regarding these terms is now provided. For example, as used herein, the term “interactive session” may refer to a digital multimedia event. In one or more embodiments, an interactive session can be supported by a social networking system (e.g., the social networking system 114) such that interactive session participants may access an interactive session via one or more social networking system gateways. Interactive sessions can be scheduled in advance or can be initiated on-the-fly. In at least one embodiment, an interactive session includes an audio broadcast that may be composed of broadcasting elements provided by the session broadcasting system 112.

As used herein, a “broadcast” can refer to digital information transmitted from one or more broadcaster computing devices to listener computing devices. For example, a broadcast can include various “broadcasting elements” such as data streams, metadata, and other types of data (e.g., system-level data). In one or more embodiments, a data stream includes a flow of information that may be transmitted from one computing device to another along an established channel between the devices. A data stream can be a video data stream including visual and audio components, an audio-only stream, or a media stream. As such, a data stream can be in any of a variety of data formats.

As used herein, an “audio-only stream” may refer to a flow of audio-only digital information from one device to another. For example, an audio-only stream can include digital information captured by a microphone of a broadcaster computing device (e.g., one of the computing devices 102a-102c shown in FIG. 1). Additionally, as used herein, a “media stream” may refer to a flow of information that can include visual information, audio information, and/or other types of data such as metadata.

As used herein, “metadata” may refer to digital information that describes other data. For example, the session broadcasting system 112 can collect, generate, and/or transmit metadata that describes elements and/or actors within an interactive session broadcast. To illustrate, the session broadcasting system 112 can collect, generate, and/or transmit metadata that describes characteristics of one or more broadcaster computing devices (e.g., the computing devices 102a-102c shown in FIG. 1). For example, as used herein, “broadcaster computing device characteristics” can refer to characteristics of a broadcaster computing device relative to an interactive session. More specifically, broadcaster computing device characteristics can include, but are not limited to, a permission level of the broadcaster computing device (e.g., that the user of the broadcaster computing device has speaker permissions in the interactive session), a mute status of the broadcaster computing device (e.g., whether a microphone of the broadcaster computing device is muted), and an active speaker status of the broadcaster computing device (e.g., whether the microphone of the broadcaster computing device is picking up speech).

As used herein, “real time communications” or “RTC” may refer to a mode of live telecommunications. For example, similar to speaking over a telephone connection, an RTC broadcaster sends audio information as soon as it is picked up by a microphone and an RTC listener hears the audio information in real-time. RTC across a single channel may generally be associated with negligible latency as a direct path exists between the RTC broadcaster and the RTC listener.

As used herein, “real-time messaging protocol” or “RTMP” may refer to a protocol for streaming audio, video, and/or data over the Internet. In one or more embodiments, RTMP engages in a type of adaptive bit-rate streaming where information may be split into fragments, packets, or segments. For example, the session broadcasting system 112 can generate RTMP audio segments that include portions of an audio stream along with other information including metadata associated with the broadcasting device where the audio stream originated, channel information, timestamp information, and so forth.

As mentioned above, the session broadcasting system 112 improves the flexibility, efficiency, and accuracy of computing devices by generating a single media stream composited with metadata from transmissions of broadcaster computing devices. FIG. 2 illustrates an overview of acts performed by session broadcasting system 112 in generating a composited single media stream.

For example, as shown in FIG. 2, the session broadcasting system 112 can perform an act 202 of receiving audio-only streams and metadata from broadcaster computing devices (e.g., the computing devices 102a-102c). In one or more embodiments, the session broadcasting system 112 receives the audio-only streams along communication channels established with each of the broadcaster computing devices. In at least one embodiment, the session broadcasting system 112 receives the audio-only streams as RTC streams including digital audio data captured by microphones of the broadcaster computing devices. Additionally, the session broadcasting system 112 can receive the metadata including information regarding one or more characteristics of the broadcasting computing devices (e.g., active speaker status, mute status).

As further shown in FIG. 2, the session broadcasting system 112 can perform an act 204 of converting the audio-only streams into a single media stream. For example, and as will be discussed in greater detail below with regard to FIG. 4, the session broadcasting system 112 can convert the RTC streams received from broadcaster computing devices within the same interactive session into a single RTMP stream. In one or more embodiments, the session broadcasting system 112 generates the single RTMP stream by fragmenting the RTC streams into audio segments or packets.

The session broadcasting system 112 can further perform an act 206 of compositing the metadata into the single media stream. For example, and as will be discussed in greater detail below with regard to FIG. 4, the session broadcasting system 112 can synchronize the metadata received from the broadcaster computing devices to the audio segments in the RTMP stream based on timestamps. In one or more embodiments, the session broadcasting system 112 can further composite header information into the audio segments such that each audio segment in the RTMP stream includes a portion of audio from one or more of the broadcaster computing devices along with metadata that may be relevant to that portion of audio.

Moreover, the session broadcasting system 112 can perform an act 208 of broadcasting the composited single media stream to one or more listener computing devices to information audio stream play updates. For example, in one embodiment, the session broadcasting system 112 can broadcast the composited single media stream by transmitting the composited single media stream to one or more listener computing devices. In additional embodiments, the session broadcasting system 112 can broadcast the composited single media stream by adding the composited audio segments of the RTMP stream to a cache that may be accessed by the one or more listener computing devices.

In one or more embodiments, the session broadcasting system 112 broadcasts the composited single media stream to inform updates by audio stream players installed on the one or more listener computing devices. For example, in at least one embodiment, the audio stream players function in concert with the session broadcasting system 112 by decoding the metadata in each audio segment while playing the audio portion of the audio segment. In one or more embodiments, the audio stream players can update a front-facing user interface (e.g., an interactive session interface as shown below in FIG. 5) to reflect the decoded metadata. For instance, the audio stream players can update the user interface to reflect a roster of broadcasters in an interactive session, a currently active broadcaster or speaker in the interactive session, and/or a mute status of one or more of the broadcasters in the interactive session.

In one or more embodiment and as mentioned above, the session broadcasting system 112 functions in concert with interactive session applications 118 installed on the computing devices 102a-102f. FIGS. 3A and 3B illustrate block diagrams of the session broadcasting system 112 operating on the server(s) 104 and the interactive session application 118 operating on the computing device 102, respectively.

In certain embodiments, the session broadcasting system 112 and/or the interactive session application 118 may represent one or more software applications or programs that, when executed by a computing device, may cause the computing device to perform one or more tasks. For example, and as will be described in greater detail below, one or more of the components 302-304 of the session broadcasting system 112 and/or the components 306-310 of the interactive session application 118 may represent software stored and configured to run on one or more computing devices, such as the devices illustrated below in FIG. 4 (e.g., the server(s) 104 and/or the computing device 102). One or more of the components 302-310 of the session broadcasting system 112 and/or the interactive session application 118 shown in FIG. 4 may also represent all or portions of one or more special-purpose computers configured to perform one or more tasks.

In one or more embodiments, as shown in FIG. 3A, the session broadcasting system 112 can include a communication manager 302 and a data transformation manager 304. Although illustrated as separate elements, one or more of the components 302-304 of the session broadcasting system 112 may be combined in additional embodiments. Similarly, in additional embodiments, the session broadcasting system 112 may include additional, fewer, or different components.

As just mentioned, the session broadcasting system 112 can include the communication manager 302. In one or more embodiments, the communication manager 302 handles communication tasks between the session broadcasting system 112 and interactive session applications 118a-118f installed on the computing devices 102a-102f. For example, the communication manager 302 can receive audio-only streams (e.g., RTC streams) as well as metadata transmissions from broadcaster computing devices. As such, the communication manager 302 can support a communication channel between one or more computing devices and the server(s) 104. Additionally, the communication manager 302 can transmit data to one or more computing devices. For example, the communication manager 302 can transmit a single media stream (e.g., an RTMP stream) to one or more listener computing devices. In one or more embodiments, the communication manager 302 can receive data requests from one or more listener computing devices and can respond by transmitting one or more audio segments of the single media stream to the requesting computing devices.

As mentioned above, and as shown in FIG. 3A, the session broadcasting system 112 can also include the data transformation manager 304. In one or more embodiments, the data transformation manager 304 can handle the tasks involved in generated a composited single media stream from audio-only streams and associated metadata. For example, and as will be discussed in greater detail below with regard to FIG. 4, the data transformation manager 304 can composite audio data, synchronize metadata fragments, generate message objects, transcode audio fragments, and generate RTMP segments. In one or more embodiments, the data transformation manager 304 outputs generated RTMP segments into the broadcasting cache 116 that can be accessed or queried by one or more listener computing devices.

In one or more embodiments, as shown in FIG. 3B, the interactive session application 118 can include a transmission manager 306, a packet decoder 308, and an interface manager 310. Although illustrated as separate elements, one or more of the components 306-310 of the interactive session application 118 may be combined in additional embodiments. Similarly, in additional embodiments, the interactive session application 118 may include additional, fewer, or different components.

As just mentioned, the interactive session application 118 can include the transmission manager 306. In one or more embodiments, the transmission manager 306 provides data to and receives data from the session broadcasting system 112. For example, when operating on a broadcaster computing device, the transmission manager 306 transmits data including an audio-only stream as well as metadata associated with that broadcaster computing device to the session broadcasting system 112. As such, the transmission manager 306 can collect or capture audio information from a microphone of the computing device 102, as well as other information associated with characteristics of the computing device 102. The transmission manager 306 can further package this characteristic information as metadata and establish a communication channel with the server(s) 104. When operating on a listener computing device, the transmission manager 306 can generate and transmit requests or queries for RTMP segments generated by the session broadcasting system 112.

As mentioned above, and as shown in FIG. 3B, the interactive session application 118 can also include a packet decoder 308. In one or more embodiments, the packet decoder 308 extracts information from audio segments (e.g., RTMP stream segments) received by the transmission manager 306. For example, the packet decoder 308 can extract and assemble audio information for playback. The packet decoder 308 can also extract and decode metadata information from the audio segments.

Additionally, as mentioned above and as shown in FIG. 3B, the interactive session application 118 can include the interface manager 310. In one or more embodiments, the interface manager 310 generates and updates an interactive session interface based on information extracted from a single media stream by the packet decoder 308. For example, during an interactive session, the interface manager 310 can generate an interactive session interface on a display of the computing device 102 that includes playback functionality of the audio information in the single media stream, as well as reflects information associated with the broadcasting computing devices within that session. To illustrate, the interface manager 310 can generate the interactive session interface including thumbnail images of the users of the broadcasting computing devices, mute status indicators indicating whether or not each of the broadcasting computing devices are muted, and a highlight element that indicates which of the broadcaster is actively speaking within the interactive session.

As mentioned above, the data transformation manager 304 of the session broadcasting system 112 can generate a composited single media stream from multiple inputs from multiple broadcasting computing devices. FIG. 4 illustrates additional detail as to the method or algorithm by which the data transformation manager 304 performs these tasks. For example, as shown in FIG. 4, the data transformation manager 304 can include multiple components for performing different tasks in a sequence.

For example, as shown in FIG. 4, the data transformation manager 304 can receive metadata and audio streams from the computing devices 102a, 102b, and 102c (e.g., broadcaster computing devices). To illustrate, a metadata handler 402 can receive metadata from the computing devices 102a-102c. In one or more embodiments, the metadata handler 402 can receive metadata reflecting one or more characteristics of the computing devices 102a-102c.

For instance, the metadata handler 402 can receive metadata including, but not limited to, a permission level associated with the users of each of the computing devices 102a-102c (e.g., whether a user has speaker permissions within an interactive session), a microphone status associated with each of the computing devices 102a-102c (e.g., whether microphones of the computing devices 102a-102c are muted or unmuted), and an active speaker status associated with each of the computing devices 102a-102c (e.g., whether a microphone of each of the computing devices 102a-102c is currently detecting or picking up sounds and/or speech). When receiving metadata from multiple computing devices (such as illustrated in FIG. 4), the metadata handler 402 can generate comprehensive metadata that reflects the most pertinent information received from the computing devices 102a. For example, the metadata handler 402 can generate comprehensive metadata indicating profile information associated with each of the computing devices 102a-102c (e.g., indicating social networking system accounts), which of computing devices 102a-102c is associated with an active speaker, and which of the computing devices 102a-102c are muted.

Additionally, a compositor 404 can receive audio-only streams from the computing devices 102a-102c. For example, the compositor 404 can receive the audio-only streams across communication channels established with the computing devices 102a-102c. In one or more embodiments, the compositor 404 can arrange the received audio-only streams into discrete portions or segments of audio information within any of a variety of audio file types (e.g., .mp3 segments). For instance, the compositor 404 can add every two seconds of an audio-only stream to an .mp3 segment. In at least one embodiment, when receiving multiple audio-only streams (such as illustrated in FIG. 4), the compositor 404 can layer or overlay the portions of the audio-only streams within an .mp3 segment. In this way, the compositor 404 can generate mp3 segments that include sounds from all of the computing devices 102a-102c (e.g., if more than one broadcaster is speaking at the same time). In additional embodiments, the compositor 404 can incrementally determine a dominant audio-only stream among the received audio-only streams (e.g., a stream that currently has the largest amount of sound or the highest volume) and can composite an increment of the dominant audio-only stream into an .mp3 segment.

In one or more embodiments, the metadata handler 402 and the compositor 404 provide outputs (e.g., compiled metadata and .mp3 segments) to an RTMP generator 406. In one or more embodiments, the RTMP generator 406 generates a single media stream including the outputs of the metadata handler 402 and the compositor 404. To illustrate, in response to the compositor 404 generating a .mp3 segment (e.g., an audio segment), the RTMP generator 406 can receive or request a corresponding metadata packet from the metadata handler 402. The RTMP generator 406 can then generate a media packet including the .mp3 segment and composited with the metadata packet. In one or more embodiments, the RTMP generator 406 can store the generated media packets in an intermediate cache then send those cached media packets for further processing at regular intervals (e.g., every two seconds). In at least one embodiment, the metadata handler 402, the compositor 404, and the RTMP generator 406 may be referred to as a compositor service.

At this point, the composited single media stream of media packets generated by the compositor service may be in a format that may be unreadable by the interactive session applications 118d-118f installed on the listener computing devices (e.g., the computing devices 102d-102f). Accordingly, as further illustrated in FIG. 4, the data transformation manager 304 can include additional processes for further transforming the media packets in the composited single media stream into a more usable format.

For example, the RTMP generator 406 can send the media packets of the composited single media stream to a message object generator 408 and an audio transcoder 410 at regular intervals (e.g., every two seconds). In one or more embodiments, the message object generator 408 keeps track of when each packet is received and further extracts the metadata information from the media packets. In at least one embodiment, the message object generator 408 generates message objects from this extracted metadata information. For example, the message object generator 408 can generate a message object that may be formatted so as to be readable by the interactive session applications 118a-118f and includes data that informs various updates within an interactive session interface generated by one or more of the interactive session applications 118a-118f. To illustrate, the message object generator 408 can generate a message object that instructs an interactive session application to update an interactive session interface displayed on a listener computing device to show that a particular broadcaster in an interactive session is muted, that a different broadcaster is actively speaking, and/or that another broadcaster has left the interactive session and is no longer on the roster of interactive session speakers.

Additionally, the audio transcoder 410 can receive the media packets of the composited single media stream and extract each audio segment therein. In one or more embodiments, the audio transcoder 410 can transform or transcode each audio segment to a different format. For example, in at least one embodiment, the interactive session applications 118a-118f are capable of playing back media in a.mp4 format. Accordingly, in at least one embodiment, the audio transcoder 410 can transcode the .mp3 audio segments into .mp4 segments.

In one or more embodiments, a segmenter 412 synchronizes the message objects generated by the message object generator 408 to the transcoded audio segments (e.g., .mp4 segments). For example, as mentioned above, the message object generator 408 can keep track of when media packets are received from the RTMP generator 406. Accordingly, the segmenter 412 can synchronize the message objects to transcoded audio segments according to these tracked timestamps. In at least one embodiment, the segmenter 412 further injects the synchronized message objects into their corresponding transcoded audio segments. Accordingly, in at least one embodiment, the segmenter 412 can generate .mp4 segments that include a portion of audio as well as metadata that corresponds to that portion of audio, where the audio and the metadata represents a compilation of information received from the computing devices 102a-102c.

In one or more embodiments, as further shown in FIG. 4, the segmenter 412 can output the generated .mp4 audio segments into the broadcasting cache 116. For example, the broadcasting cache 116 can act as a data buffer where the generated .mp4 audio segments are temporarily stored while listener computing devices 102d-102f (e.g., listener computing devices) request the audio segments for streaming. In that embodiment, the broadcasting cache 116 may retain audio segments for a threshold amount of time during an interactive session. For example, once the threshold amount of time expires, the broadcasting cache 116 may either release or delete the audio segments or may provide the audio segments to another storage mechanism that assembles the audio segments into a recording for later use.

As just mentioned, in one or more embodiments, the computing devices 102d-102f request segments of a composited single media stream for playback from the broadcasting cache 116. For example, in at least one embodiment, the interactive session applications 118d-118f installed on computing devices 102d-102f utilize an adaptive bitrate streaming technique-such as dynamic adaptive streaming over HTTP (DASH)—to request or fetch audio segments from the broadcasting cache 116. In that embodiment, the broadcasting cache 116 makes each audio segment available at different bit rates. Accordingly, an interactive session application 118 can determine its current network conditions and request an audio segment at a bit rate that can be played back without causing playback issues (e.g., stalls, rebuffering).

In at least one embodiment, the session broadcasting system 112 further reduces latency within the network environment 100 (e.g., as shown in FIG. 1) by utilizing predictive DASH. To illustrate, in that embodiment, the interactive session applications 118a-118f utilize computational models, neural networks, or other artificial intelligence techniques or algorithms to predict what network conditions will during a future time period (e.g., for the next five seconds). The interactive session applications 118a-118f can then request or fetch audio segments for that time period at an optimal bit rate.

Components 116, and 402-412 of the data transformation manager 304 may be co-located on a single server or may be located on two or more separate servers. For example, in some embodiments, the components 402-406 may be located on a first server, while the components 408-412 and 116 may be located on a second server. In yet additional embodiments, the components 402-406 may be located on a first server, the components 408-412 may be located on a second server, and the broadcasting cache 116 may be located on a third server.

For each audio segment received by an interactive session application 118 from the composited single media stream, the interactive session application 118 can playback the audio of that segment. The interactive session application 118 can further update an interactive session interface based on the metadata represented within that segment. FIG. 5 illustrates an interactive session interface 504 on a display 502 of the computing device 102d (e.g., a listener computing device).

In one or more embodiments, the interactive session application 118d can generate the interactive session interface 504 in response to the initiation of an interactive session. As mentioned above, an interactive session can be a multimedia event where one or more broadcasters speak within a virtual space that can include any number of listeners. As discussed above, the interactive session interface 504 can include playback functionality to play the audio information (e.g., the .mp4 segments) of the composited single media stream over one or more speakers (e.g., transducers) of the computing device 102d. Additionally, an interactive session includes additional interactive features whereby interactive session participants (e.g., broadcasters and listeners) can add social networking system reactions (e.g., likes, thumbs-ups, hearts, etc.), contribute comments to a digital comment thread, read real-time textual transcriptions of what the broadcasters are saying, forward invitations to the interactive session within the social networking system 114, and so forth.

Moreover, as further shown in FIG. 5, the interactive session application 118d can update the interactive session interface 504 based on metadata that may be passed from the session broadcasting system 112 within the audio segments of the composited single media stream. For example, the interactive session application 118d can update the interactive session interface 504 based on this metadata to include the broadcaster thumbnails 506a, 506b, 506c, 506d, and 506e. To illustrate, for every audio segment received or fetched by the interactive session application 118d, the interactive session application 118d can extract and analyze the metadata from the audio segment to determine identities of the broadcasters within the interactive session.

For instance, the interactive session application 118d can extract profile information associated with each of the broadcaster computing devices associated with the interactive session. More specifically, the interactive session application 118d can extract social networking system usernames and/or account identifiers from the audio segments. Utilizing this information, the interactive session application 118d can query the social networking system 114 for broadcaster screen names, broadcaster profile pictures, and other information. In at least one embodiment, the interactive session application 118d generates the broadcaster thumbnails 506a-506e based on this queried information.

In one or more embodiments, the interactive session application 118d can extract this broadcaster profile information from each received audio segment of the composited single media stream. In at least one embodiment, the interactive session application 118d takes no action when there is no change in broadcaster information from one audio segment to the next. Upon determining that there is a change in broadcaster information (e.g., due to a broadcaster leaving the interactive session or a new broadcaster joining the interactive session), however, the interactive session application 118d can update the interactive session interface 504 to reflect this change by adding or removing broadcaster thumbnails.

As further shown in FIG. 5, the interactive session application 118d can extract additional information from the audio segments to further update the interactive session interface 504. For example, in one or more embodiments, the interactive session application 118d can extract mute status information from each received audio segment. In at least one embodiment, the interactive session application 118d updates the interactive session interface 504 with mute status indicators 508 associated with each broadcaster thumbnail 506a-506e. For instance, in response to extracting mute status information from an audio segment indicating all broadcaster computing devices except for that of the active speaker or broadcaster are muted, the interactive session application 118d can update the interactive session interface 504 to include the mute status indicators 508 associated with the corresponding broadcaster thumbnails 506a, 506c, 506d, and 506e.

Additionally, in one or more embodiments, the interactive session application 118d can extract active speaker information from the audio segments to further update the interactive session interface 504. For example, the interactive session application 118d can extract active speaker information that indicates which of the broadcaster client devices is broadcasting active speech from at least one of the broadcasters associated with the interactive session. In response to identifying this broadcasting client device and associated broadcaster, the interactive session application 118d can update the interactive session interface 504 to include a highlight element 510 associated with the broadcaster thumbnail 506b corresponding to the identified broadcaster.

As shown in FIG. 5, the interactive session application 118d can generate the highlight element 510 to approximate a stylized thumbnail border (e.g., a “halo”) surrounding the corresponding broadcaster thumbnail 506d. In additional embodiments, the interactive session application 118d can generate the highlight element 510 to make the associated broadcaster thumbnail appear enlarged, to change a color of the active speaker's name, to add an animated overlay to the active speaker's name or broadcaster thumbnail, and so forth. In response to analyzing information from an audio segment indicating the active speaker has changed, the interactive session application 118d can update the interactive session interface 504 so that the highlight element 510 is associated with the broadcaster thumbnail of the newly identified active speaker.

Thus, as described above and throughout the present application, the session broadcasting system 112 efficiently broadcasts audio to an audience of unlimited size, while accurately passing metadata from the broadcasting computing devices through multiple data transformations down to the listener computing devices. As discussed above, the session broadcasting system 112 utilizes an architecture that avoids problems common to example communication systems. For example, by utilizing transforming RTC data into an RTMP data stream, the session broadcasting system 112 may not be limited to a maximum number of RTC connections it can support between broadcasters and listeners. Instead, the session broadcasting system 112 can service requests for audio segments from any number of listener computing devices. Additionally, by having interactive session applications 118 predictively fetch audio segments from the RTMP stream from a centralized caching mechanism, the session broadcasting system 112 further reduces latency across the entire communication network such that listeners of an interactive session feel like they are listening to a real-time conversation among broadcasters with little to no lag.

### EXAMPLE EMBODIMENTS

Example 1: A computer-implemented method for generating a composited single media stream from multiple broadcaster devices may include receiving, at a communication server, audio-only streams and metadata from a plurality of broadcaster computing devices, converting the audio-only streams from the plurality of broadcaster computing devices into a single media stream, compositing the metadata from the plurality of broadcaster computing devices into the single media stream, and broadcasting the composited single media stream to one or more listener computing devices to inform audio stream player updates based on the metadata from the plurality of broadcaster computing devices that reflect one or more broadcaster computing device characteristics.

Example 2: The computer-implemented method of Example 1, wherein receiving the audio-only streams and metadata from the plurality of broadcaster computing devices comprises: receiving RTC audio streams from the plurality of broadcaster computing devices, and receiving metadata reflecting one or more broadcaster computing devices comprising broadcaster permission levels of each of the broadcaster computing devices, a mute status of each of the broadcaster computing devices, or an active speaker status of each of the broadcaster computing devices.

Example 3: The computer-implemented method of any of Examples 1 and 2, wherein converting the audio-only streams from the plurality of broadcaster computing devices into the single media stream comprises converting the received RTC audio streams to a single RTMP data stream.

Example 4: The computer-implemented method of any of Examples 1-3, wherein converting the received RTC audio streams into the single RTMP data stream comprises generating a plurality of audio segments comprising portions of the RTC audio streams.

Example 5: The computer-implemented method of any of Examples 1-4, wherein compositing the metadata from the plurality of broadcaster computing devices into the single media stream comprises: synchronizing the metadata from the plurality of broadcaster computing devices to the plurality of audio segments and injecting the synchronized metadata into the plurality of audio segments.

Example 6: The computer-implemented method of any of Examples 1-5, wherein broadcasting the composited single media stream to the one or more listener computing devices is in response to receiving requests from audio stream players installed on the one or more listener computing devices.

Example 7: The computer-implemented method of any of Examples 1-6, wherein broadcasting the composited single media stream to the one or more listener computing device to inform audio stream player updates comprises broadcasting the composited single media stream to the one or more listener computing devices to cause the audio stream players to update a highlight element within an interactive session interface to indicate a currently active speaker from among broadcasters associated with the broadcasting computing devices.

Example 8: The computer-implemented method of any of Example 1-7, wherein the one or more broadcaster computing device characteristics indicate a number of available broadcaster computing devices, a number of muted broadcaster computing devices, and a broadcaster computing device associated with a currently active speaker within the audio-only streams.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, at a communication server, audio-only streams and metadata from a plurality of broadcaster computing devices;
converting the audio-only streams from the plurality of broadcaster computing devices into a single media stream;
compositing the metadata from the plurality of broadcaster computing devices into the single media stream; and
broadcasting the composited single media stream to one or more listener computing devices to inform audio stream player updates based on the metadata from the plurality of broadcaster computing devices that reflect one or more broadcaster computing device characteristics.

2. The computer-implemented method as recited in claim 1, wherein receiving the audio-only streams and metadata from the plurality of broadcaster computing devices comprises:
receiving real time communication (RTC) audio streams from the plurality of broadcaster computing devices; and
receiving metadata reflecting one or more broadcaster computing devices comprising broadcaster permission levels of each of the plurality of broadcaster computing devices, a mute status of each of the plurality of broadcaster computing devices, or an active speaker status of each of the plurality of broadcaster computing devices.

3. The computer-implemented method as recited in claim 2, wherein converting the audio-only streams from the plurality of broadcaster computing devices into the single media stream comprises converting the received RTC audio streams to a single real-time messaging protocol (RTMP) data stream.

4. The computer-implemented method as recited in claim 3, wherein converting the received RTC audio streams into the single RTMP data stream comprises generating a plurality of audio segments comprising portions of the RTC audio streams.

5. The computer-implemented method as recited in claim 4, wherein compositing the metadata from the plurality of broadcaster computing devices into the single media stream comprises:
synchronizing the metadata from the plurality of broadcaster computing devices to the plurality of audio segments; and
injecting the synchronized metadata into the plurality of audio segments.

6. The computer-implemented method as recited in claim 1, wherein broadcasting the composited single media stream to the one or more listener computing devices is in response to receiving requests from audio stream players installed on the one or more listener computing devices.

7. The computer-implemented method as recited in claim 6, wherein broadcasting the composited single media stream to the one or more listener computing devices to inform audio stream player updates comprises broadcasting the composited single media stream to the one or more listener computing devices to cause the audio stream players to update a highlight element within an interactive session interface to indicate a currently active speaker from among broadcasters associated with the plurality of broadcasting computing devices.

8. The computer-implemented method as recited in claim 1, wherein the one or more broadcaster computing device characteristics indicate a number of broadcaster computing devices, a number of muted broadcaster computing devices, and a broadcaster computing device associated with a currently active speaker within the audio-only streams.

9. A system comprising:
at least one physical processor; and
physical memory comprising computer-executable instructions that, when executed by the physical processor, cause the physical processor to perform acts comprising:
receiving, at a communication server, audio-only streams and metadata from a plurality of broadcaster computing devices;
converting the audio-only streams from the plurality of broadcaster computing devices into a single media stream;
compositing the metadata from the plurality of broadcaster computing devices into the single media stream; and
broadcasting the composited single media stream to one or more listener computing devices to inform audio stream player updates based on the metadata from the plurality of broadcaster computing devices that reflect one or more broadcaster computing device characteristics.

10. The system as recited in claim 9, further comprising computer-executable instructions that, when executed by the physical processor, cause the physical processor to perform the act of receiving the audio-only streams and metadata from the plurality of broadcaster computing devices by:
receiving real time communication (RTC) audio streams from the plurality of broadcaster computing devices; and
receiving metadata reflecting one or more broadcaster computing devices comprising broadcaster permission levels of each of the plurality of broadcaster computing devices, a mute status of each of the plurality of broadcaster computing devices, or an active speaker status of each of the plurality of broadcaster computing devices.

11. The system as recited in claim 10, further comprising computer-executable instructions that, when executed by the physical processor, cause the physical processor to perform the act of converting the audio-only streams from the plurality of broadcaster computing devices into the single media stream by converting the received RTC audio streams to a single real-time messaging protocol (RTMP) data stream.

12. The system as recited in claim 11, wherein converting the received RTC audio streams into the single RTMP data stream comprises generating a plurality of audio segments comprising portions of the RTC audio streams.

13. The system as recited in claim 12, further comprising computer-executable instructions that, when executed by the physical processor, cause the physical processor to perform the act of compositing the metadata from the plurality of broadcaster computing devices into the single media stream by:
synchronizing the metadata from the plurality of broadcaster computing devices to the plurality of audio segments; and
injecting the synchronized metadata into the plurality of audio segments.

14. The system as recited in claim 9, further comprising computer-executable instructions that, when executed by the physical processor, cause the physical processor to perform the act of broadcasting the composited single media stream to the one or more listener computing devices in response to receiving requests from audio stream players installed on the one or more listener computing devices.

15. The system as recited in claim 14, further comprising computer-executable instructions that, when executed by the physical processor, cause the physical processor to perform the act of broadcasting the composited single media stream to the one or more listener computing devices to inform audio stream player updates by broadcasting the composited single media stream to the one or more listener computing devices to cause the audio stream players to update a highlight element within an interactive session interface to indicate a currently active speaker from among broadcasters associated with the plurality of broadcasting computing devices.

16. The system as recited in claim 9, wherein the one or more broadcaster computing device characteristics indicate a number of broadcaster computing devices, a number of muted broadcaster computing devices, and a broadcaster computing device associated with a currently active speaker within the audio-only streams.

17. A non-transitory computer-readable medium comprising one or more computer-executable instructions that, when executed by at least one processor of a computing device, cause the computing device to perform acts comprising:
receiving, at a communication server, audio-only streams and metadata from a plurality of broadcaster computing devices;
converting the audio-only streams from the plurality of broadcaster computing devices into a single media stream;
compositing the metadata from the plurality of broadcaster computing devices into the single media stream; and
broadcasting the composited single media stream to one or more listener computing devices to inform audio stream player updates based on the metadata from the plurality of broadcaster computing devices that reflect one or more broadcaster computing device characteristics.

18. The non-transitory computer-readable medium as recited in claim 17, further comprising one or more computer-executable instructions that, when executed by the at least one processor of the computing device, cause the computing device to perform the act of receiving the audio-only streams and metadata from the plurality of broadcaster computing devices by:
receiving real time communication (RTC) audio streams from the plurality of broadcaster computing devices; and
receiving metadata reflecting one or more broadcaster computing devices comprising broadcaster permission levels of each of the plurality of broadcaster computing devices, a mute status of each of the plurality of broadcaster computing devices, or an active speaker status of each of the plurality of broadcaster computing devices.

19. The non-transitory computer-readable medium as recited in claim 18, further comprising one or more computer-executable instructions that, when executed by the at least one processor of the computing device, cause the computing device to perform the act of converting the audio-only streams from the plurality of broadcaster computing devices into the single media stream by converting the received RTC audio streams to a single real-time messaging protocol (RTMP) data stream, wherein converting the received RTC audio streams into the single RTMP data stream comprises generating a plurality of audio segments comprising portions of the RTC audio streams.

20. The non-transitory computer-readable medium as recited in claim 19, further comprising one or more computer-executable instructions that, when executed by the at least one processor of the computing device, cause the computing device to perform the act of compositing the metadata from the plurality of broadcaster computing devices into the single media stream by:
synchronizing the metadata from the plurality of broadcaster computing devices to the plurality of audio segments; and
injecting the synchronized metadata into the plurality of audio segments.
